(19) United States
(12) Patent Application Publication
(10) Pub. No.: US 2009/0129247 A1
(43) Pub. Date: May 21, 2009

(54) METHOD AND SYSTEM FOR IMPROVING DOMAIN FORMATION IN A FERROELECTRIC MEDIA AND FOR IMPROVING TIP LIFETIME

(75) Inventors: Quan A. Tran, Fremont, CA (US); Qing Ma, San Jose, CA (US); Donald Edward Adams, Pleasanton, CA (US); Nickolai Belov, Los Gatos, CA (US); Yevgeny Vasilievich Anoikin, Fremont, CA (US)

Correspondence Address: FLIESLER MEYER LLP, 650 CALIFORNIA STREET, 14TH FLOOR, SAN FRANCISCO, CA, 94108, US

(73) Assignee: NANOCHIP, INC., Fremont, CA (US)

(21) Appl. No.: 12/269,817

(22) Filed: Nov. 12, 2008

Related U.S. Application Data
(60) Provisional application No. 60/989,783, filed on Nov. 21, 2007.

(51) Int. Cl. G11B 9/00

(52) U.S. Cl. 369/126; 427/131; G9B/9

(57) ABSTRACT

An information storage device comprises a ferroelectric media, write circuitry to provide a first signal and a second signal to the ferroelectric media, a tip platform and a cantilever operably associated with the tip platform. A tip extends from the cantilever toward the ferroelectric media and includes a first conductive material communicating the first signal from the write circuitry to the ferroelectric media and a second conductive material communicating the second signal from the write circuitry to the ferroelectric media. A insulating material arranged between the first conductive material and the second conductive material to electrically isolate the first conductive material from the second conductive material.

### CLAIM OF PRIORITY

This application claims benefit to the following U.S. Provisional Patent Application:

U.S. Provisional Patent Application No. 60/989,783 entitled “METHOD AND SYSTEM FOR IMPROVING DOMAIN FORMATION IN A FERROELECTRIC MEDIA AND FOR IMPROVING TIP LIFETIME,”by Tran et al., filed Nov. 21, 2007, Attorney Docket No. NANO-01090US0.

### TECHNICAL FIELD

This invention relates to high density information storage.

### BACKGROUND

Software developers continue to develop steadily more data intensive products, such as ever-more sophisticated, and graphic intensive applications and operating systems. As a result, higher capacity memory, both volatile and non-volatile, has been in persistent demand. Add to this demand the need for capacity for storing data and media files, and the confluence of personal computing and consumer electronics in the form of portable media players (PMPs), personal digital assistants (PDAs), sophisticated mobile phones, and laptop computers, which has placed a premium on compactness and reliability.

Nearly every personal computer and server in use today contains one or more hard disk drives (HDD) for permanently (or semi-permanently) storing frequently accessed data. Every mainframe and supercomputer is connected to hundreds of HDDs. Consumer electronic goods ranging from camcorders to digital data recorders use HDDs. While HDDs store large amounts of data, HDDs consume a great deal of power, require long access times, and require “spin-up” time on power-up. Further, HDD technology based on magnetic recording technology is approaching a physical limitation due to super paramagnetic phenomenon. Data storage devices based on scanning probe microscopy (SPM) techniques have been studied as future ultra-high density (>1Tbit/in2) systems. There is a need for techniques and structures to read and write to a media that facilitate desirable data bit transfer rates, desirable areal densities, and desirable mean-time-before-failure.

### BRIEF DESCRIPTION OF THE DRAWINGS

Further details of the present invention are explained with the help of the attached drawings in which:

FIG. 1: FIG. 1A is a cross-sectional side view of an information storage device including a ferroelectric media; FIG. 1B is a top view of the surface of the ferroelectric media of FIG. 1A.

FIG. 2: FIG. 2A is a cross-sectional side view of an embodiment of an information storage device in accordance with the present invention; FIG. 2B is a top view of the surface of the ferroelectric media of FIG. 2A.

FIG. 3 is a flowchart of an embodiment of a method of writing information in the information storage device of FIG. 2 in accordance with the present invention.

FIGS. 4A-4C are cross-sectional flow diagrams illustrating an embodiment of a method in accordance with the present invention of forming a tip including a sleeve arranged over the tip to reduce wear at a terminus of the tip.

FIGS. 5A-5F are cross-sectional process flow diagrams illustrating an embodiment of a method in accordance with the present invention of forming a tip including a pad to reduce wear at a terminus of the tip.

FIGS. 6A-6E are cross-sectional process flow diagrams illustrating an alternative embodiment of a method in accordance with the present invention of forming a tip including a pad to reduce wear at a terminus of the tip.

FIG. 7 is a side cross-sectional view of a further embodiment of a head extending from a cantilever and including a pad to reduce wear at a sensor of a tip.

FIGS. 8A-8F are process flow diagrams illustrating an alternative embodiment of a method in accordance with the present invention of forming the head of FIG. 7.

FIG. 9 is a side cross-sectional view of a still further embodiment of a head extending from a cantilever and including a pad to reduce wear at a sensor of a tip.

FIGS. 10A-10D are process flow diagrams illustrating an still further embodiment of a method in accordance with the present invention of forming the tip of FIG. 9.

### DETAILED DESCRIPTION

Ferroelectrics are members of a group of dielectrics that exhibit spontaneous polarization—i.e., polarization in the absence of an electric field. Ferroelectric materials can retain permanent electric dipoles and are the dielectric analogue of ferromagnetic materials, which may display permanent magnetic behavior. Ferroelectric films have been proposed as promising recording media, with a bit state corresponding to the spontaneous polarization direction of the media, wherein the spontaneous polarization direction is controllable by way of application of an electric field. Ferroelectric films can achieve ultra high bit recording density because the thickness of a 180° domain wall in ferroelectric material is in the range of a few lattices (1-2 nm).

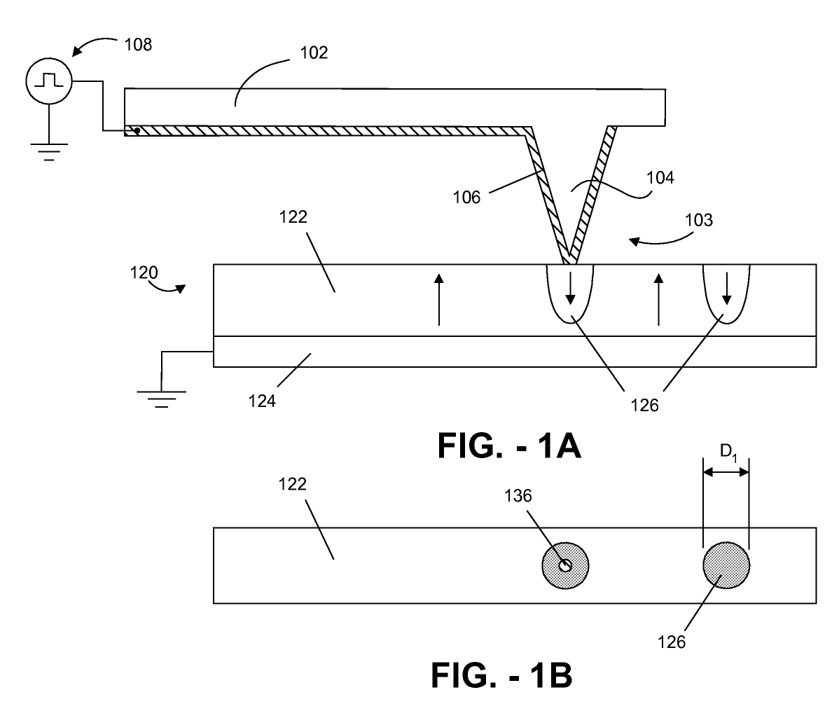

Referring to FIG. 1A, an information storage device 100 is shown comprising a probe tip 103 (referred to hereafter as a tip) extending from a cantilever 102 and contacting a surface of a ferroelectric media 120. The cantilever 102 and a core 104 of the tip can be formed, for example, from silicon. A conductive material 106 is arranged over the core 104 and the cantilever 102 so that circuitry can be placed in electrical communication with the ferroelectric media 120 by way of the tip 103. The ferroelectric media 120 has an asymmetric electrical structure comprising a ferroelectric layer 122 disposed over a conductive bottom electrode 124. Although not shown, the conductive bottom electrode 124 can be formed over a supporting substrate (e.g., silicon), isolated from the substrate by one or more layers including an insulating layer. The conductive layer 106 of the tip 103 acts as a top electrode when contacting the surface of the ferroelectric media 120. Information is stored as domains within the ferroelectric layer 122 having dipoles of opposing orientation (e.g., up orientation and down orientation). It is noted that in some contexts, a domain can refer to a discrete unit such as a data bit comprising material having non-uniform dipole orientation. However, as used herein, domain refers to a volume of a ferroelectric material having uniform dipole orientation and defined by domain walls. As used herein, a data bit refers to a discrete unit of information. A domain can comprise one or more data bits, or alternatively a data bit can comprise one or more domains. A current or voltage source 108 can apply a signal comprising a pulse or other waveform to affect a polarization of the ferroelectric layer 122. As shown, the ferroelectric layer 122 includes a bulk polarization having an up orientation that can be associated with one of “1” and “0”. The signal can be applied to switch the orientation of a portion of the ferroelectric layer 122 to cause a down orientation associated with the other of “1” and “0”.

Referring to FIG. 1B, a contact area 136 between the tip 103 and the surface of the ferroelectric layer 122 is substantially smaller than the surface area of the ferroelectric media and the asymmetric electrical structure of the ferroelectric media causes an asymmetric relationship of polarization energy and ferroelectric-to-paraelectric transition energy for the up domains and down domains that can result in undesirable influences of neighboring domains on one another. Additionally, the asymmetric structure can subject the ferroelectric layer to film stresses during manufacturing which can affect the ferroelectric properties of the ferroelectric layer. Thus, an asymmetric structure can exacerbate instability of the polarization of domains in the ferroelectric layer. As shown, the up domain can interact with the down domain to expand in size and consequently reduce in size the down domain. The interaction between the domains can halt where equilibrium is reached as wall energy of the down domain increases as a result of decreasing domain size. However, it is possible that the polarization of the entire down domain can be flipped to have an up orientation by neighboring up domains, resulting in lost information. Where the bulk orientation of the ferroelectric layer is up, the down domain flipped to an up domain can be said to be “unswitched.”

In a high density information storage format, the contact area 136 between the tip 103 and the surface of the ferroelectric layer 122 is typically small when compared with the thickness of the ferroelectric layer 122. An electric field associated with a point of application of the signal extends away from the point of application both through the ferroelectric layer 122 and across the ferroelectric layer 122. Nucleation and growth of a domain associated with a spontaneous polarization generally follows the shape of the electric field or is influenced by the shape of the electric field. Further, the electric field has a non-uniform distribution, and the electric field due to any single charge falls off as the square of the distance from that charge. As shown, a down domain 126 extends through a portion of the ferroelectric layer 122, but not through the entire thickness of the ferroelectric layer 122. Further, the down domain 126 has an areal diameter D1 larger than the contact area 136. The interaction of the down domain with the unswitched portion of the ferroelectric layer disposed between the down domain and the bottom electrode (i.e., underneath the down domain and through the ferroelectric layer) is stronger than the interaction of the switched domain with the unswitched portion of the ferroelectric layer across the ferroelectric layer (i.e., neighboring up domains), and a greater source of instability. The unswitched portion between the down domain and the bottom electrode can flip the down domain, making it disappear within minutes or days depending how deep the down domain penetrates the ferroelectric layer. The electric field can be increased to drive the growth of the down domain 126 toward the bottom electrode 124; however, increasing the electric field (e.g., by increasing the applied voltage) can cause the areal diameter D1 to further increase, reducing the areal density of the information.

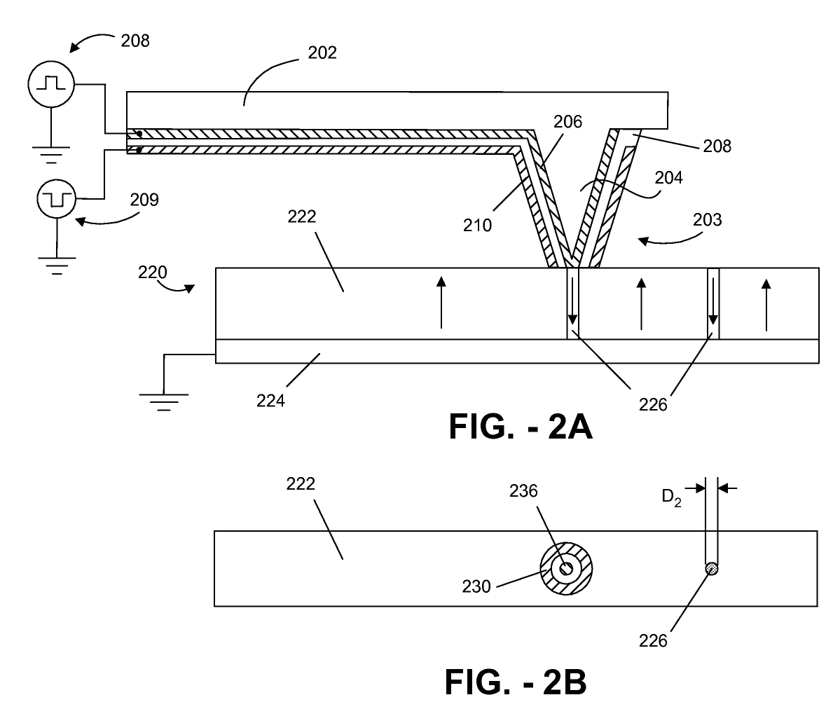

Information storage devices and methods in accordance with the present invention can be applied to increase depth of domain penetration through a ferroelectric layer while maintaining or increasing an areal density of information within the ferroelectric layer by limiting areal diameter of the switched domain. Referring to FIG. 2A, an embodiment of an information storage device in accordance with the present invention is shown comprising a tip 203 extending from a cantilever 202 and contacting a surface of a ferroelectric media 220. In an embodiment, the cantilever 202 and a core 204 of the tip can be formed from silicon, although in other embodiments, the cantilever and/or core 204 of the tip can be formed from some other material, such as diamond-like carbon (DLC) or silicon nitride. In still other embodiments, the core 204 can provide a frame that is subsequently partly or completely etched or otherwise removed, for example as described in U.S. Publ. No. 2007-0041238 entitled “HIGH DENSITY DATA STORAGE DEVICES WITH READ/WRITE PROBES WITH HOLLOW OR REINFORCED TIPS,” filed Jul. 8, 2005, incorporated herein by reference.

As above, a first conductive material (also referred to herein as an inner conductive material) 206 is arranged over the core 204 and the cantilever 202 so that circuitry can be placed in electrical communication with the ferroelectric media 220 to communicate a first signal to the ferroelectric media 220. A second conductive material (also referred to herein as an outer conductive material) 210 is arranged over the tip in coaxial relationship with the first conductive material 206 of the tip 203. The second conductive material 210 communicates a second signal from circuitry of the information storage device to the ferroelectric media 220. An insulating material 208 can be formed between the first conductive material 206 and the second conductive material 210 to isolate the two materials, and resist interference of the first and second signal. In a coaxial relationship, the second conductive material has a contact area 230 that confines the contact area 236 of the first conductive material in spaced relationship resulting from the presence as shown of the insulating material. As shown, the tip has a frusto-conical shape, although in practice the sidewalls of the tip can be curved.

A second current or voltage source 209 can apply a second signal comprising a pulse or other waveform to generate an electric field of opposite polarity to a second portion of the ferroelectric layer 222 generally in neighboring proximity to the first portion of the ferroelectric layer 222 to which the first signal is applied. The electric fields produced by the first and second signals are vector quantities. The resultant electric field across the ferroelectric layer includes reduced field near the interface of the two electric fields attributable to the two signals. Growth of the domain is suppressed by the characteristics of the resultant electric field; therefore, the domain produced by the first conductive material is more limited in areal diameter D2 then, for example, a tip applying a single signal, as shown in FIG. 1A. If the first signal is provided by a voltage source, the applied voltage can be increased to drive the domain to the bottom electrode, without substantially increasing the areal diameter D2. A second signal communicated by the second conductive material can be effective in limiting across-film domain growth at an applied voltage that is below a threshold switching voltage for inducing a domain to flip from a switched to an unswitched state, maintaining the integrity of switched domains when the second conductive material overlaps the switched domain. The magnitude of the applied voltage of the first signal required to propagate a domain through the ferroelectric layer 222 will vary with a thickness of the ferroelectric layer 222. For example, it has been observed that for a PZT film of 30 nm thickness approximately 5V is needed for switching, while for a similar PZT film of 50 nm thickness approximately 12 V is needed for switching.

Referring to FIG. 3, an embodiment of a method of writing information in an information storage device is shown in accordance with the present invention. A tip including an inner conductive layer and an outer conductive layer is positioned over a target portion of a ferroelectric media for writing information (Step 100). An outer signal source (e.g., a voltage source) can provide a pulse or other waveform to the outer conductive layer of the tip (Step 102). Where the signal is an applied voltage, the applied voltage can be below a threshold dipole switching voltage to avoid unintended erasure. An inner signal source can provide a pulse or other waveform to the inner conductive layer of the tip (Step 104). The pulse or other waveform is applied so that a domain of uniform dipole orientation is formed through a ferroelectric layer of the ferroelectric media, to a bottom electrode (Step 106). The inner signal source is removed from electrical communication with the ferroelectric media (Step 108). The outer signal source is then removed from electrical communication with the ferroelectric media (Step 110), and the tip is moved from over the target portion (Step 112). Preferably the first signal is applied to the first conductive material within a window of time in which the second signal is applied to the second conductive material. The first and second signal can be applied contemporaneously to minimize a write time for the domain. Changing the first signal applied by way of the first conductive member independent of the second signal can affect the bit size. Erasure occurs when the applied voltage of the second signal is larger than a threshold voltage. By keeping the applied voltage of the second signal below the threshold voltage, erasure of adjacent bits is avoided.

It is noted that while the contact area of the first and second conductive material as shown is described as “co-axial,” such a relationship is preferable or found useful and not a requirement. For applications in which all cross-film domain growth is intended to be limited, the second conductive material is arranged to apply a second electric field that confines a first electric field applied by the first conductive material. In other embodiments, the first and second conductive materials need not be arranged in a nested relationship. It may be desirable in some applications for the contact area of the second conductive material to partially confine the contact area of the first conductive material, or to limit or redirect domain growth through strategic arrangement of the contact area of the second conductive material.

A tip proposed for use in probe storage devices typically includes a terminus having with a nano-scale radius of curvature that can range, for example, from 10 to 100 nm. Proposed methods of reading and/or writing indicia to a media include applying force to the tip at the tip-media interface so that the tip is urged against the media. The applied force can be relatively small, but movement of the tip along the media surface is sufficiently kinetic that the applied force causes mechanical wear to the tip. Further, many proposed techniques include applying current or voltage to the media by way of the tip (or vice-versa). The contact area of the tip and the media can be very small, and can result in a current density high enough to cause material transfer between the media and tip. Abrasive movement of the tip and transfer of material between the tip and media cause the tip to age and wear. Addressing the abrasive movement of the tip and transfer of material can provide improved tip longevity and consequently improved device lifetime. Embodiments of tips and methods for forming such tips in accordance with the present invention can include provide novel geometries to improve wear characteristics at the tip-media interface thereby improving tip longevity and device lifetime.

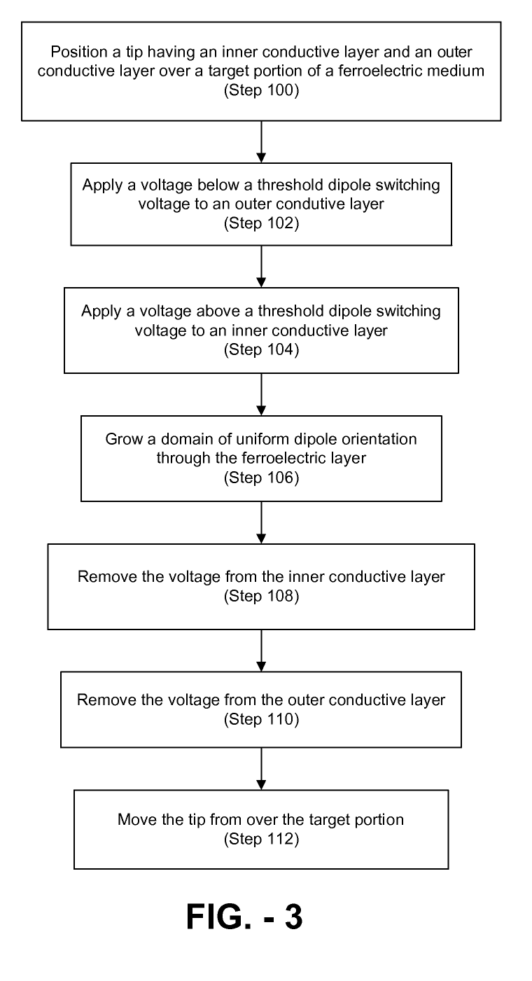

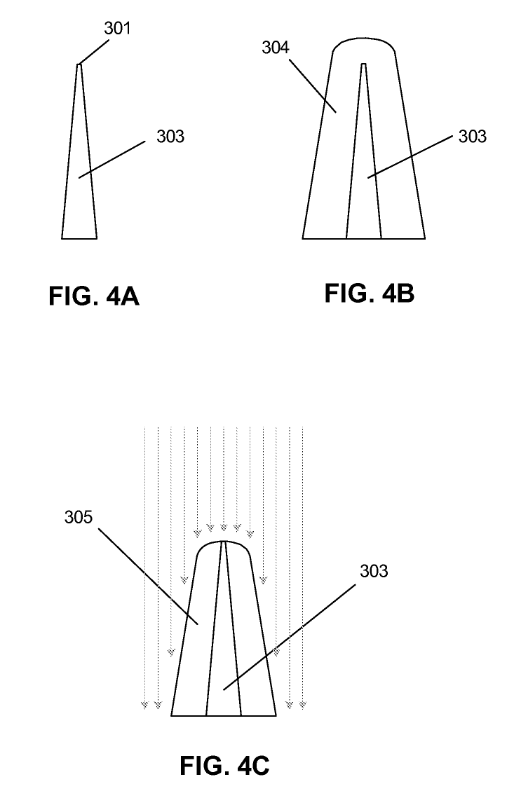

FIGS. 4A-4C illustrate an embodiment of a method in accordance with the present invention for forming a tip 303 including a sleeve 305 arranged around the tip 303 to reduce wear at a terminus 301 of the tip 303. FIG. 4A illustrates a tip 303. The tip 303 can be formed from materials such as single-crystal silicon and diamond-like carbon (DLC), and fabricated using anisotropic and/or isotropic processes. Further, the tip 303 need not by monolithic, and can include additional structure, such as carbon nanotubes extending from the end of the tip. Referring to FIG. 4B, chemical vapor deposition (CVD) is performed to deposit a conformal dielectric layer 304 over the tip 303. The conformal dielectric layer can comprise silicon dioxide or some other conformal, insulating material such as alumina (Al₂O₃). The tip 303 and conformal dielectric layer 304 are then subjected to a directional etch (such as plasma-based anisotropic etch) applied perpendicular to the terminus 301 (i.e., along the length of the page of FIG. 4C). A portion of the conformal dielectric layer 304 along the sides of the tip is reduced, while a portion of the conformal dielectric layer 304 formed over the terminus 301 is substantially removed until the terminus 301 of the tip 303 is exposed, forming a tip 303 having a sleeve 305. As the tip 303 is urged against the media, the force applied between the media and the tip 303 is partially distributed along the sleeve 305 surrounding the terminus 301, thereby reducing a tip wear inducing agent. Further, if the sleeve 305 a material that is harder than the tip material, the tip 303 may become slightly receded within the sleeve 305 due to an initial wear or as a result of the directional etch. Removing the terminus 301 from contact with the media surface substantially reduces wear of the terminus 301; however, a sufficient application of breakdown voltage can bridge the gap and place the tip 301 in electrical communication with the media.

In other embodiments of tips in accordance with the present invention can include head comprising a pad and a tip wherein the pad has a contact area with the media that is, for example, two orders of magnitude larger than a terminus of the tip but generally coplanar with the tip so that contact force applied between a media and the head is distributed over a relatively larger area. The tip can be desirously held in electrical communication with the media; however, the wear producing abrasive forces applied to the tip can be reduced, and the wear of the tip can be coincidentally reduced. Alternatively, the pad can be formed so that a gap exists between a terminus of a tip and a media surface. The pad can provide a sliding surface that contacts the media so that a minimal gap between the terminus and the media of, for example, less than a nanometer. An electric field can be applied between the tip and the media that is sufficient to provide a breakdown voltage through the gap, allowing reading, writing, sensing of bits in the media, but reducing wear of the tip.

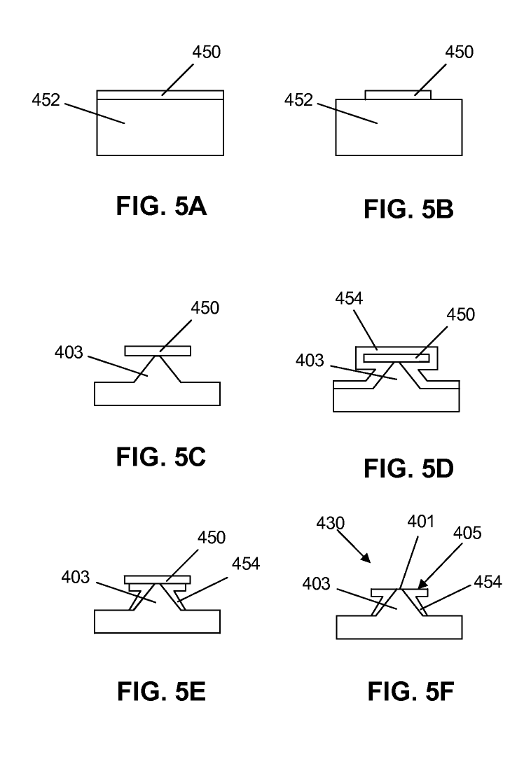

FIGS. 5A-5F illustrate a further embodiment of a method in accordance with the present invention for forming a tip comprising fabricating a head 430 including the tip 403 and a pad 405 to reduce wear at a terminus 401 of the tip 403. A hardmask 450 is formed over a substrate 452 or other film or surface in which a tip profile is to be formed (FIG. 5A). The substrate 452 can comprise mono-crystalline silicon, polysilicon, amorphous silicon, materials other than silicon. The hardmask 450 can comprise any non-polymer or organic “soft” material that provides a sufficiently desirable etch selectivity to the substrate 452 or underlying layer or surface. For example, the hardmask 450 can comprise silicon nitride. The hardmask 450 can be patterned and etched (FIG. 5B) having planar dimensions that generally allow for a desired tip profile when undergoing subsequent processing. The tip 403 is subsequently formed by isotropically etching the substrate 452 (FIG. 5C). A conformal layer 454 is deposited over the hardmask 450 and tip 403. The conformal layer can comprise silicon dioxide, or alternatively some other hard material such as silicon carbide. The structure is anisotropically etched to remove a portion of the conformal layer 454 that is not masked by the footprint of the hardmask 450, leaving behind a portion of the conformal layer 454 underneath the hardmask 450 and along the sides of the tip 403. The hardmask 450 is then removed by way of a wet or dry etch and a head 430 is formed. The portion of the conformal layer 454 underneath the hardmask 450 is now exposed to act as a pad 405 across which force is disturbed when the tip is urged against a media. Abrasive forces applied to the terminus 401 of the tip 403 are reduced in magnitude by the pad 405 over which a portion of the abrasive forces are distributed (as described above). Some thermal oxide may form over the terminus 401, which thermal oxide can be removed by a light etch that leaves the pad 405 substantially intact following removal of the hardmask 450.

A head 430 that is located at an end of a cantilever can contact a media surface such that a leading edge of the pad 405 contacts the media while a gap exists between a trailing edge of the pad 405 and the media and between the terminus 401 of the tip 403 and the media. Such heads 430 can be “trained” by moving the head 430 against a surface of the media so than an initial wear substantially reduces the leading edge of the pad 405 and consequently the gap between the terminus 401 of the tip 403 and the media. Further, as mentioned above, some small gap may be desirable where the gap is sufficiently small such that a breakdown voltage can bridge the gap while avoiding transferal of abrasive forces to the terminus 401.

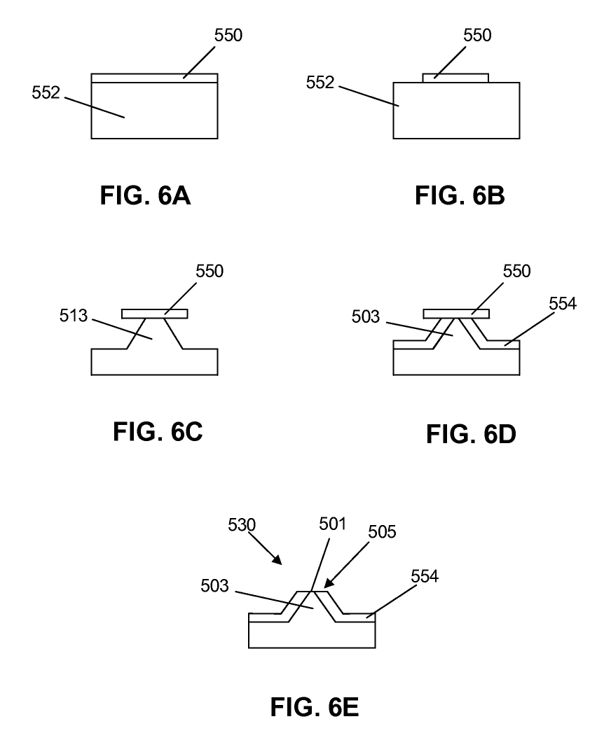

FIGS. 6A-6E illustrate a still further embodiment of a method in accordance with the present invention for forming a tip comprising fabricating a head 530 including the tip 503 and a pad 505 to reduce wear at a terminus 501 of the tip 503. A hardmask 550 is formed over a substrate 552 or other film or surface in which a tip profile is to be formed (FIG. 6A). The substrate 552 can comprise mono-crystalline silicon, polysilicon, amorphous silicon, materials other than silicon. As above, the hardmask 550 can comprise any non-polymer or organic “soft” material that provides a sufficiently desirable etch selectivity to the substrate 552 or underlying layer or surface, such as silicon nitride. The hardmask 550 can be patterned and etched (FIG. 6B) having planar dimensions that generally allow for a desired tip profile when undergoing subsequent processing. A profile 513 (i.e., pre-formed tip) can be subsequently formed by isotropically etching the substrate 552 (FIG. 6C). The profile 312 is oxidized (i.e., a thermal oxide layer 554 is grown over the profile 513) with the hardmask 550 arranged over the profile 513. The profile 513 sharpens as oxidation forms, consuming a portion of the substrate 552 at the periphery of the tip profile 513. The structure is anisotropically etched to remove a portion of the thermal oxide layer 554 that is not masked by the footprint of the hardmask 550, leaving behind a portion of the thermal oxide layer 554 underneath the hardmask 550 and along the sides of the tip 503. The hardmask 550 is then removed by way of a wet or dry etch and a head 530 is formed. The portion of the thermal oxide layer 554 underneath the hardmask 550 is now exposed to act as a pad 505 across which force is disturbed when the tip is urged against a media. Abrasive forces applied to the terminus 501 of the tip 503 are reduced in magnitude by the pad 505 over which a portion of the abrasive forces are distributed (as described above). Some thermal oxide may form over the terminus 501, which thermal oxide can be removed by a light etch that leaves the pad 505 substantially intact following removal of the hardmask 550.

As above, a leading edge of the pad 505 may contact the media while a gap exists between a trailing edge of the pad 505 and the media and between the terminus 501 of the tip 503 and the media. Such heads 530 can “trained” by moving the head 530 against a surface of the media so than an initial wear substantially reduces the leading edge of the pad 505 and consequently the gap between the terminus 501 of the tip 503 and the media. Further, as mentioned above, some small gap may be desirable where the gap is sufficiently small such that a breakdown voltage can bridge the gap while avoiding transferal of abrasive forces to the terminus 501.

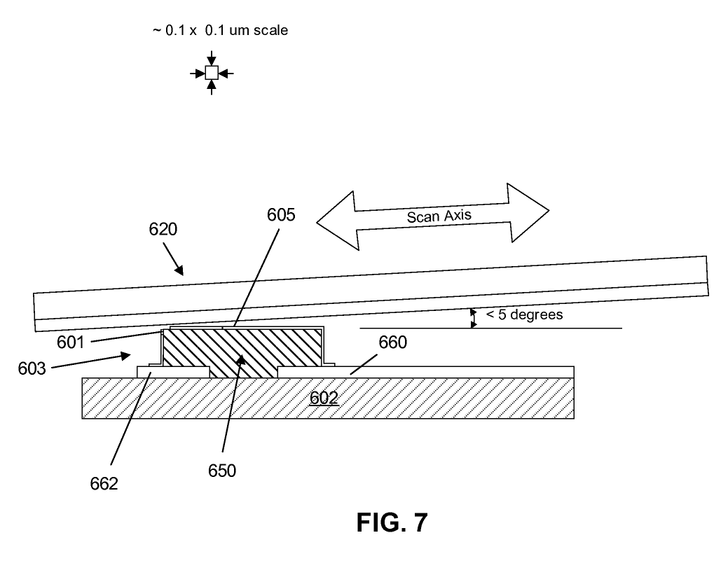

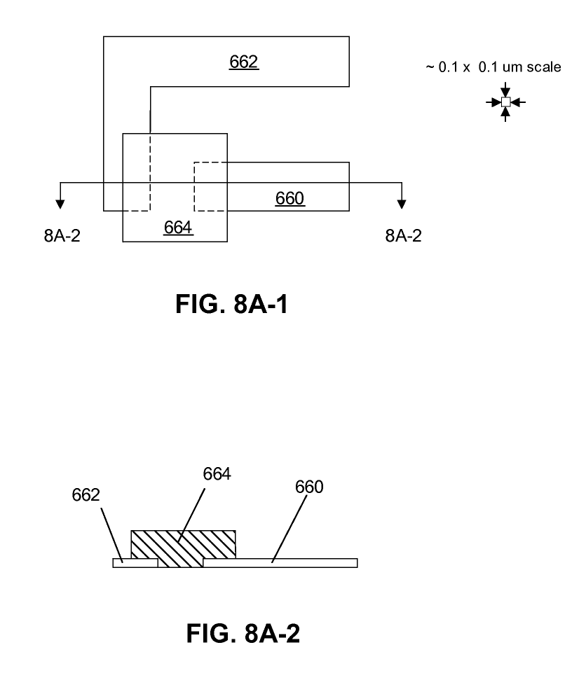

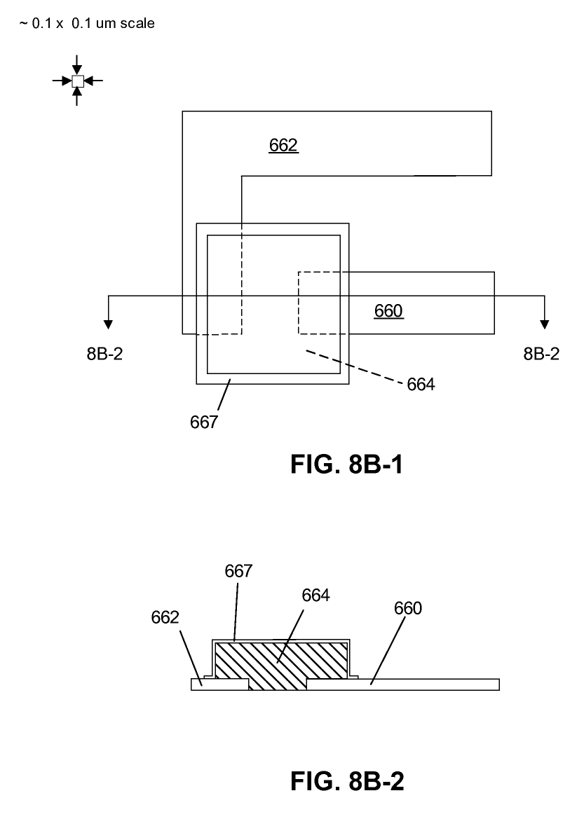

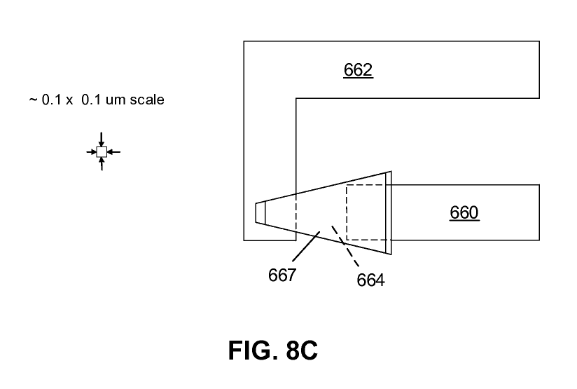

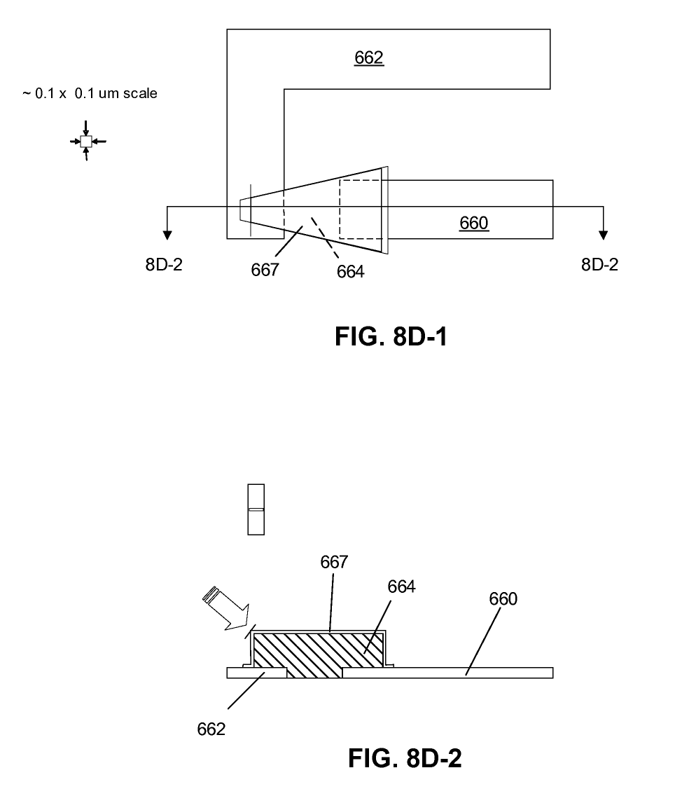

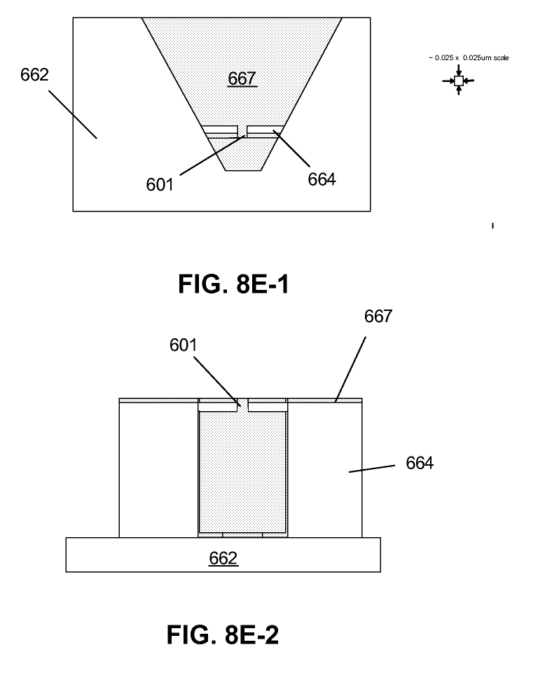

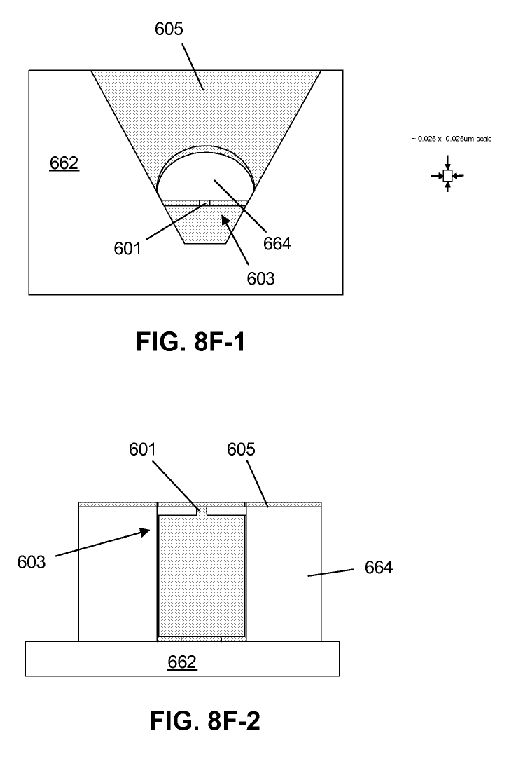

Some methods of fabricating tips as described above in FIGS. 1-6C can comprise pre-forming a tip profile by isotropic etch, and forming a final tip profile using processes that consume silicon such as thermal oxidation, or alternatively silicidation. Referring to FIGS. 7-8D, in still further embodiments methods in accordance with the present invention for fabricating wear resistant tips can comprise forming a tip through deposition and anisotropic etch techniques. FIG. 7 is a cross-sectional view of an embodiment of a media device comprising a cantilever 602 and head 650 in accordance with the present invention. The head 650 includes a terminus 601 of a tip 603 (also referred to herein as a sensor) that has a generally uniform cross-section along the usable depth of the sensor 601 and is arranged so that a force of the head 650 against the media 620 is distributed at least partially along a pad 605 of the head 650. Embodiments of methods to fabricate the head 650 can be used to concurrently form a shield trace 660 (also referred to as a guard), for example to apply methods of reading ferroelectric domains using radio-frequency (RF) sensing techniques as described in U.S. patent application Ser. No. 11/688,806 entitled “SYSTEMS AND METHODS OF WRITING AND READING A FERRO-ELECTRIC MEDIA WITH A PROBE TIP,” filed Mar. 20, 2007, and incorporated herein by reference. The pad 605 can be comprised of an exposed portion of a dielectric 664 formed to isolate the guard 660 from a signal trace 662. As can be seen, in an embodiment the cantilever 602 deploys from a tip die (not shown) to position the sensor 601 over the media 620. An contact angle is formed between a top surface of the head 650 and a surface of the media 620. The offset angle corresponds approximately to an angle at which the cantilever 602 extends toward the media 620 to span a gap between the tip die and the media 620. For example, as shown the angle formed between the top surface of the head 650 and the surface of the media 620 is less than 5°. The sensor 601 is formed on a leading edge of the head 650 so that the angled arrangement of the head 650 relative to the surface of the media 620 places the sensor 601 in communicative proximity to the media 620. A portion of the dielectric 650 is exposed from the leading edge toward the trailing edge to provide the pad 605. A conductive layer 667 is provided to form the sensor and the guard. The conductive layer 667 is sufficiently thin and the offset angle of the head 650 is sufficiently large so that the pad 605 (rather than the guard) contacts the surface of the media 620. However, the guard is placed in communicative proximity to the media surface to improve a usable signal provided to the signal trace 662.

FIGS. 8A-8E illustrate progressive steps of a process flow of an embodiment of a method in accordance with the present invention for fabricating a head 650 for use in a media device as shown in FIG. 7. The process flow can be preceded or succeeded by formation of a cantilever 602 over which the head 650 is fabricated. Referring to FIG. 8A, a guard 660 and a signal trace 662 can be fabricated by forming one or more layers of conductive material on a cantilever 602 and/or substrate, and patterning and etching the one or more layers to form discrete traces. The guard 660 and the signal trace 662 can be fabricated simultaneously or alternatively using separate series of steps. A core 664 is formed bridging the guard 660 and the signal trace 662. The core 664 can be formed by depositing a layer of dielectric material over the guard 660 and signal trace 662. The layer of dielectric material is then patterned and etched. Preferably, a dielectric material is deposited that is harder than a material used to fabricate the sensor 601 so that the pad 605 surrounding the sensor 601 does not wear more quickly than the sensor 601. In other embodiments, a separate pad layer can be deposited over the core 664 comprising a material having sufficient hardness to provide desired wear characteristics of a pad. Such an approach can provide flexibility in selecting the core 664 material.

Referring to FIG. 8B, a conformal layer 667 of conductive material is deposited, sputtered, or otherwise formed over the core 664 and traces 660,662. The conductive material and formation process are preferably selected to achieve a desired uniformity of thickness across multiple heads on a tip die, as well as to achieve a desired uniformity of thickness between tip dies. A thickness of the conductive layer 667 substantially defines a down-track length of the sensor 601, which down-track length influences a minimum bit length formable on the media 620. Metal can be deposited in a very thin layer having a thickness that is on the order of atomic layers (e.g. ˜5 nm). Preferably the down-track length of the sensor 601 is about a target down-track length of a bit cell. The thinner the conductive layer 667, the smaller the potential size of the bit cell. The conductive layer 667 is patterned and etched to reduce the footprint of the conductive layer 667 so that it roughly conforms with the footprint of the core 664 while contacting the guard 660 and the signal trace 662.

Referring to FIG. 8C, the core 664 and the conductive layer 667 are etched to reduce a mass of the head 650 and remove a portion of the conductive layer 667 electrically joining the guard 660 to the signal trace 662 along the sides of the head 650. The guard 660 and signal trace 662 are electrically isolated to allow extraction of a data signal. Further processing will electrically sever the guard 660 from the signal trace along the top surface of the head 650. As shown, the head 650 is etched so that the head 650 tapers toward the signal trace 662. In other embodiments, the head 650 can be etched so that the head 650 tapers toward the guard 660. In still other embodiments, the head 650 can be etched so that it is substantially rectangular in shape. One of ordinary skill in the art, upon reflecting on the present teachings, will appreciate the myriad shapes with which the head 650 can be formed.

A width of the sensor 601 can be defined through use of lithography techniques capable of defining features in the sub-micron regime. Preferably, the cross-track width is the wider than a down-track length so that servoing is made more tractable. For example, the width can be roughly twice a length of the sensor 601, although the width and length need not have a fixed ratio. In an embodiment, the width of the sensor 601 can be defined using electron beam (e-beam) lithography. E-beam lithography is a pattern forming technique used in mask-making and research and development. E-beam widths may be on the order of nanometers; however, e-beam lithography is typically not preferred in semiconductor process manufacturing flows due to the large number of features commonly formed in transistor and circuit mask layers. However, media device in accordance with the present invention can have a number of sensors several orders of magnitude smaller than a mask layer of a common semiconductor process manufacturing flow. Alternatively, the width of the sensor 601 can be defined using some other nanoscale technique, such as nanoimprint lithography. It should be noted that while the width of the sensor 601 is preferably defined in a nanoscale range, the alignment of the sensor 601 along the leading edge of the head 650 need not be precise, but rather can be positioned anywhere along a substantial portion of the leading edge. Positioning of the head 650 can be adjusted by the media device during operation to account for offset of the sensor 601 relative to the head 650 (for example, by way of a memory controller referencing a table of offsets).

Once the width of the sensor 601 is defined in a mask layer by patterning, the head 650 is etched by way of directional ion milling. The ion milling removes material from the unmasked portions of the head 650. Referring to FIG. 8E, the ion milling step removes a substantial portion of the conductive layer 667 disposed along the leading edge of the head 650 to form an aperture that exposes the dielectric core 664 beneath the conductive layer 667. The conductive layer 667 is electrically connected between the guard 660 and the signal trace 662 by the sensor 601 over the leading edge of the head 650. As can be seen in the top view of FIG. 8E-1, the down-track length of the sensor 601 is defined by the thickness of the conductive layer 667 which is exposed by the ion milling.

Once the aperture is formed in the conductive layer 667, the electrical connection between the guard 660 and the signal trace 662 can be severed to form electrically discrete components. Referring to FIG. 8F, the head 650 is lapped (i.e. gently grinded) so that a portion of the conductive layer 667 is removed. Lapping can be performed on the wafer level or at the device level, and can be accomplished using lapping equipment or any technique capable of removing a small amount of material (e.g., chemical-mechanical polishing (CMP)). A portion of the conductive layer 667 lapped from the head 650 can be determined using closed loop control by monitoring the connection between the guard 660 and the signal trace 662. As the connection is severed, the closed loop control can determine sufficient lapping. Once lapping is complete, a head guard 668 is formed, electrically connected with the guard 660 for providing a reference signal to a read circuit. Further, the sensor 601 is approximately flush with the exposed dielectric, which acts as a pad 605 to reduce wear of the sensor 601. As described above in reference to FIG. 7, the head 650 is arranged at an angle relative to a surface of the media (e.g. 50) so that the pad 605 is placed in contact or near contact with the media surface and the head guard 668 is substantially removed from contact with the media surface.

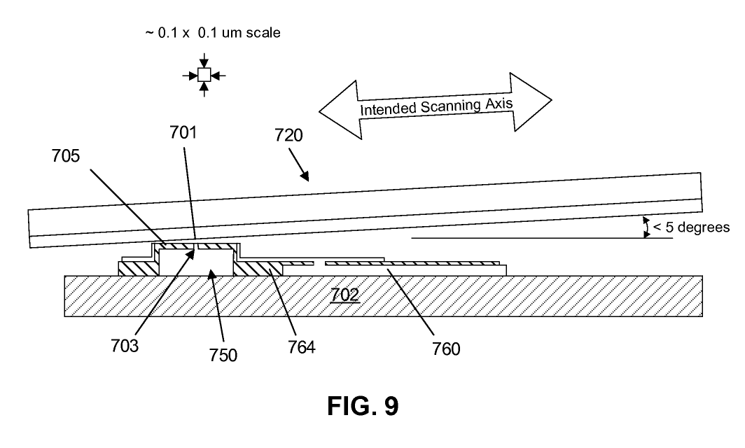

FIG. 9 is a cross-sectional view of a still another embodiment of a media device comprising a cantilever 702 and head 750 in accordance with the present invention. The head 750 includes a terminus 701 of a tip 703 (also referred to herein as a sensor) that has a generally uniform cross-section along the usable depth of the sensor 701 and is arranged so that a force of the head 750 against the media 720 is distributed at least partially along a pad 705 of the head 750. As above, embodiments of methods to fabricate the head 750 can be used to concurrently form a guard 760 for use, for example, in radio-frequency (RF) sensing techniques. The pad 705 can be comprised of an exposed portion of a dielectric 764. As can be seen, in an embodiment the cantilever 702 deploys from a tip die (not shown) to position the sensor 701 over the media 720. A contact angle is formed between a top surface of the head 750 and a surface of the media 720. The offset angle corresponds approximately to an angle at which the cantilever 702 extends toward the media 720 to span a gap between the tip die and the media 720. For example, as shown the angle formed between the top surface of the head 750 and the surface of the media 720 is less than 5°. The sensor 701 as shown is formed approximately near a center of the head 750 so that the angled arrangement of the head 750 relative to the surface of the media 720 introduces a gap between the media 720 and the sensor 701. The gap can be sufficiently small that a breakdown voltage applied to the sensor 701 is sufficient to place the sensor 701 in communication with the media 720. A conductive layer 767 is provided to form the sensor and the guard. The guard is placed in communicative proximity to the media surface to improve a usable signal provided to the signal trace.

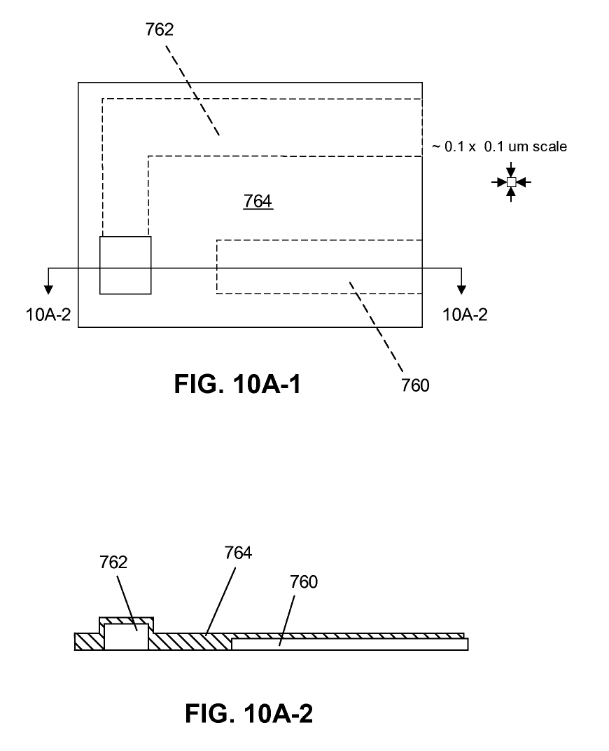

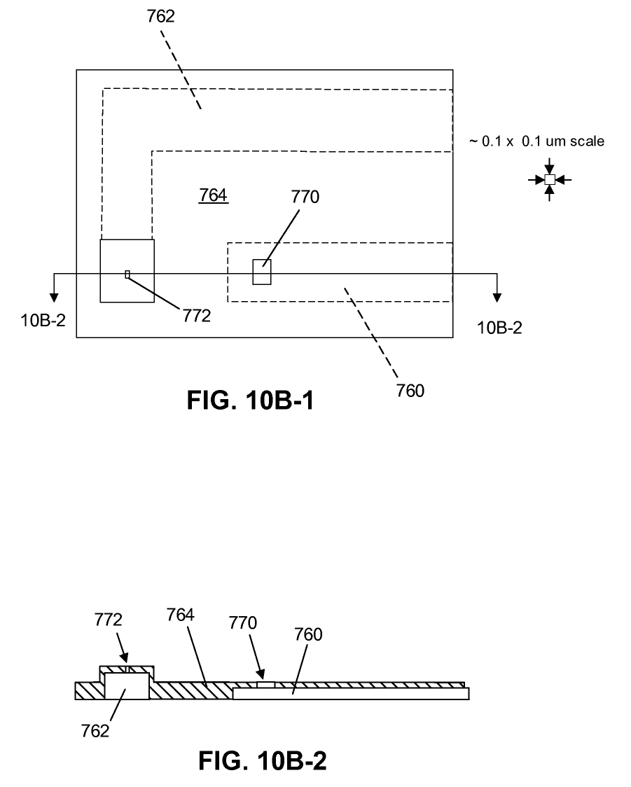

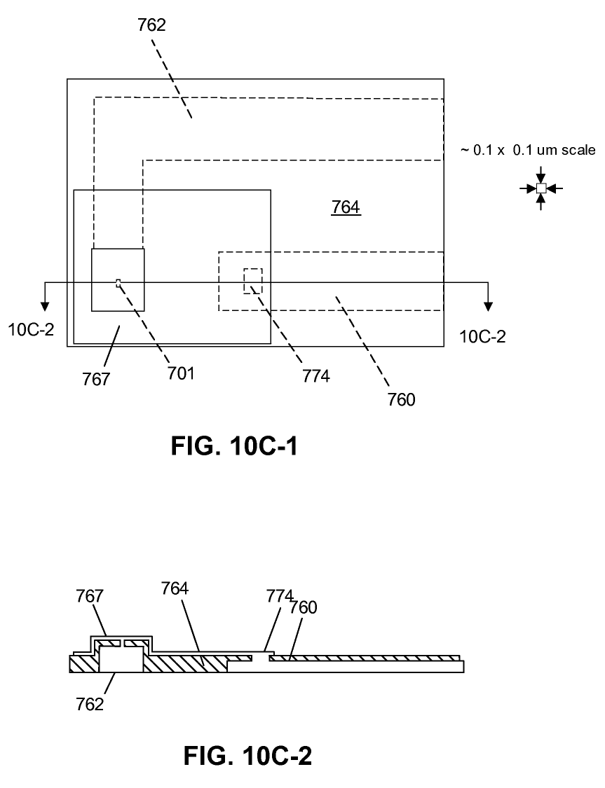

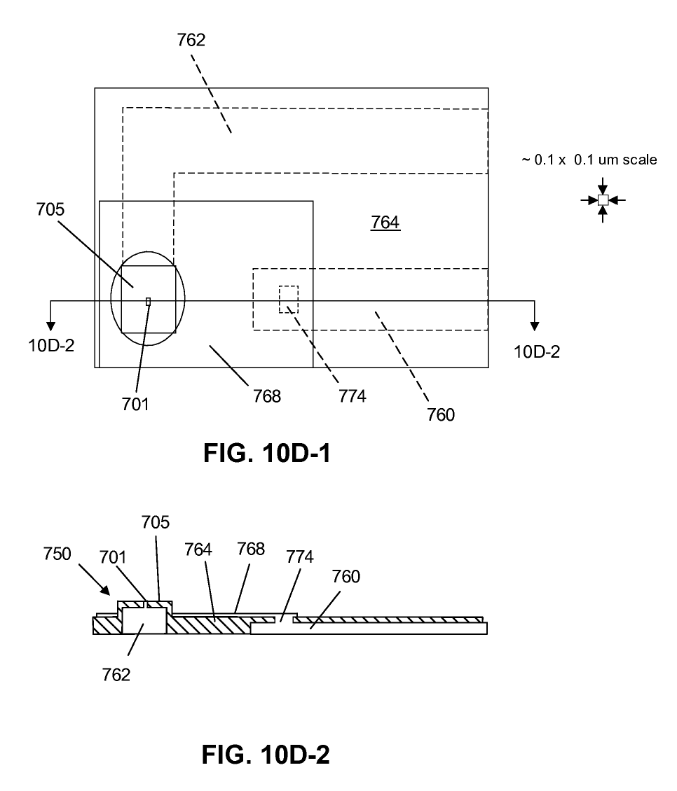

FIGS. 10A-10E illustrate progressive steps of a process flow of an alternative embodiment of a method in accordance with the present invention for fabricating a head 750 for use in a media device as shown in FIG. 9. The process flow can be preceded or succeeded by formation of a cantilever 702 over which the head 750 is fabricated. Referring to FIG. 10A, a guard 760 and a signal trace 762 can be fabricated by forming one or more layers of conductive material on a cantilever 702 and/or substrate, and patterning and etching the one or more layers to form discrete traces. The guard 760 and the signal trace 762 can be fabricated simultaneously or alternatively using separate series of steps. Multiple deposition and/or etch steps can be performed to fabricate the form of the head 750 at one end of the signal trace 762, which is a step height taller than the guard 760. A dielectric layer 764 is formed covering the conductive structures. Preferably, a dielectric material is deposited that is harder than a material used to fabricate the sensor 701 so that the pad 705 surrounding the sensor 701 does not wear more quickly than the sensor 701. In other embodiments, a separate pad layer can be deposited over the dielectric layer 764 comprising a material having sufficient hardness to provide desired wear characteristics of a pad. Such an approach can provide flexibility in selecting the dielectric layer 764 material.

Referring to FIG. 10B, the dielectric layer 764 (and pad layer where present) is etched to define a thru-hole 770 (also referred to herein as a via) exposing the guard 760 and a sensor hole 772 associated with the head 750 and exposing the signal trace 762. Planar dimensions of the sensor hole 772 can be defined (as above) through use of lithography techniques capable of defining features in the sub-micron regime. Preferably, the cross-track width is the wider than a down-track length so that servoing is made more tractable. For example, the width can be roughly twice a length of the sensor 701, although the width and length need not have a fixed ratio. In an embodiment, the planar dimensions of the sensor hole 772 can be defined using electron beam (e-beam) lithography. Alternatively, the planar dimensions of the sensor hole 772 can be defined using some other nanoscale technique, such as nanoimprint lithography. It should be noted that while the width of the sensor hole 772 is preferably defined in a nanoscale range, the alignment of the sensor hole 772 along the head 750 need not be precise, but rather can be positioned anywhere along a substantial portion of the head 750. Positioning of the head 750 can be adjusted by the media device during operation to account for offset of the sensor 701 relative to the head 750 (for example, by way of a memory controller referencing a table of offsets). Planar dimensions and tolerances are relatively more forgiving for the via 770 than for the sensor hole 772. The via 770 need only allow a subsequent plug 774 (see FIG. 10D) formed within the via 770 to have impedance within an acceptable range of impedance values so that a guard 760 senses an appropriate reference value. Once the planar dimensions of the sensor hole 772 and via 770 are defined in a mask layer by patterning, the dielectric layer 764 is etched. The dielectric layer 764 is etched using a principally anisotropic process so that the sensor hole 772 dimensions are not enlarged. In a preferred embodiment, the dielectric layer 764 is etched using electron-cyclotron resonance (ECR) reactors. ECR reactors provide good anisotropy of features by producing desirable passivation layers on the sidewalls of the features.

Referring to FIG. 10C, a conformal layer 767 of conductive material is deposited, sputtered, or otherwise formed over the dielectric layer 764 and within the sensor hole 772 and via 770. Optionally, a highly conformal material such as titanium nitride (TiN) can be formed within the sensor hole 772 and via 770 to act as a barrier metal and/or an adhesion layer. The conductive material and formation process are preferably selected to fill the sensor hole 772 to provide consistent electrical characteristics for sensors formed across a wafer (or substrate), and between wafers.

Once the conductive layer 767 is formed, the electrical connection between the sensor 701 and the guard 760 can be severed to form electrically discrete components. Referring to FIG. 10D, the head 750 is lapped (i.e. gently grinded) so that a portion of the conductive layer 767 is removed. Lapping can be performed on the wafer level or at the device level, and can be accomplished using lapping equipment or any technique capable of removing a small amount of material (e.g., chemical-mechanical polishing (CMP)). A portion of the conductive layer 767 lapped from the head 750 can be determined using closed loop control by monitoring the connection between the guard 760 and the signal trace 762. As the connection is severed, the closed loop control can determine sufficient lapping. Once lapping is complete, a head guard 768 is formed, electrically connected with the guard 760 for providing a reference signal to a read circuit. Further, the sensor 701 is approximately flush with the exposed dielectric, which acts as a pad 705 to reduce wear of the sensor 701.

The foregoing description of the present invention has been presented for purposes of illustration and description. It is not intended to be exhaustive or to limit the invention to the precise forms disclosed. Many modifications and variations will be apparent to practitioners skilled in this art. The embodiments were chosen and described in order to best explain the principles of the invention and its practical application, thereby enabling others skilled in the art to understand the invention for various embodiments and with various modifications as are suited to the particular use contemplated. It is intended that the scope of the invention be defined by the following claims and their equivalents.

1. An information storage device comprising:
a ferroelectric media;
write circuitry to provide a first signal and a second signal to the ferroelectric media;
a tip platform;
wherein one or both of the ferroelectric media and the tip platform is movable relative to the other of the ferroelectric media and the tip platform;
a cantilever operably associated with the tip platform;
a tip extending from the cantilever toward the ferroelectric media, the tip including:
a first conductive material communicating the first signal from the write circuitry to the ferroelectric media;
a second conductive material communicating the second signal from the write circuitry to the ferroelectric media; and
an insulating material arranged between the first conductive material and the second conductive material to electrically isolate the first conductive material from the second conductive material.

2. The information storage device of claim 1, wherein the first signal is a first voltage and the second signal is a second voltage having an opposite polarity from the first voltage.

3. The information storage device of claim 2, wherein the second voltage is substantially the same magnitude as the first voltage.

4. The information storage device of claim 1, wherein the cantilever is formed from silicon and the first conductive material is formed over a silicon core.

5. The information storage device of claim 2, wherein the first signal and the second signal are communicated to the ferroelectric media contemporaneously.

6. The information storage device of claim 1, wherein the first signal is communicated to a first portion of the ferroelectric media and the second signal is communicated to a second portion of the ferroelectric media; and
wherein the second portion at least partially confines the first portion.

7. The information storage device of claim 1, wherein the first conductive material, the second conductive material and the insulating material are coaxially arranged along the tip.

8. An information storage device comprising:
a ferroelectric media;
write circuitry to apply a first signal and a second signal to the ferroelectric media;
a tip including:
a first conductive material contacting the ferroelectric media and communicating the first signal from the write circuitry to a first portion of the ferroelectric media,
a second conductive material contacting the ferroelectric media and communicating the second signal from the write circuitry to a second portion of the ferroelectric media at least partially confining the first portion.

9. The information storage device of claim 8 further comprising an insulating material arranged between the first conductive material and the second conductive material to electrically isolate the first conductive material from the second conductive material.

10. The information storage device of claim 8, wherein the first signal is a first voltage and the second signal is a second voltage having an opposite polarity from the first voltage.

11. The information storage device of claim 10, wherein the second voltage is substantially the same magnitude as the first voltage.

12. The information storage device of claim 8, wherein the tip is formed of silicon.

13. The information storage device of claim 8, wherein the first signal and the second signal are communicated to the ferroelectric media contemporaneously.

14. The information storage device of claim 9, wherein the first conductive material, the second conductive material and the insulating material are coaxially arranged along the tip.

15. A method of storing information, comprising:
arranging a tip in communicative proximity to a ferroelectric media, wherein the tip includes a first conductive material to communicate a first signal and a second conductive material to communicate a second signal;
communicating the first signal to the ferroelectric media so that a portion of the ferroelectric media has a target spontaneous polarization; and
confining an areal diameter of the portion by communicating the second signal to the ferroelectric media.

16. The method of claim 15, wherein confining an areal diameter of the portion further comprises communicating the second signal contemporaneously with the first signal so that the second signal causes a spontaneous polarization opposite the target spontaneous polarization.

17. An information storage device comprising:
a media;
a cantilever;
a head extending from the cantilever toward the media, the head including:
a tip adapted to electrically communicate with the media;
a pad adapted to contact the media when the tip is in electrical communication with the media, thereby reducing wear of the tip.

18. The information storage device of claim 17, wherein the tip has a substantially uniform cross-section along a thickness of the tip.

19. The information storage device of claim 17, wherein the head further includes a guard electrically isolated from the tip for communicating a reference signal to a red circuit.

20. A method of forming a head including a tip for electrically communicating with a media in an information storage device comprising:
forming a guard on a substrate;
forming a signal trace on a substrate;
forming a core of dielectric material overlapping the guard and the signal trace;
forming a conductive layer over the core so that the conductive layer contacts the guard and the signal trace;
removing a portion of the core on each side of the core so that the conductive layer is confined to a top surface of the guard, the signal trace, and the core;
defining a sensor by selectively removing a portion of the conductive layer at the leading edge of the core, the sensor having a length defined by a thickness of the conductive layer; and
removing a portion of the conductive layer between the sensor and the guard so that the sensor is electrically connected with the signal trace and electrically isolated from the guard.

21. The method of claim 20, wherein the guard and the signal trace are formed contemporaneously by forming a conductive layer on a substrate, patterning the conductive layer, and etching the conductive layer to define discrete traces.

22. The method of claim 20, wherein the substrate is a cantilever.

23. The method of claim 20, wherein defining the sensor further comprises masking the conductive layer to define a width of the sensor one of electron beam lithography and nanoimprint lithography.

24. The method of claim 20, wherein removing a portion of the conductive layer between the sensor and the guard includes lapping.

25. A method of forming a head including a tip for electrically communicating with a media in an information storage device comprising:
forming a guard on a substrate;
forming a signal trace on a substrate;
forming a layer of dielectric material overlapping the guard and the signal trace;
defining a sensor by selectively removing a portion of the layer of dielectric material arranged over the signal trace;
defining a via by selectively removing a portion of the layer of dielectric material arranged over the guard;
forming a conductive layer over the layer of dielectric material so that the conductive layer contacts the signal trace through the sensor and the guard through the via; and
removing a portion of the conductive layer surrounding the sensor so that the sensor is electrically connected with the signal trace and electrically isolated from the guard.

26. The method of claim 25, wherein the guard and the signal trace are formed contemporaneously by forming a conductive layer on a substrate, patterning the conductive layer, and etching the conductive layer to define discrete traces.

27. The method of claim 25, wherein the substrate is a cantilever.

28. The method of claim 25, wherein one or both of the sensor and via is defined by one of electron beam lithography and nanoimprint lithography.

29. The method of claim 25, wherein removing a portion of the conductive layer between the sensor and the guard includes lapping.
